(19) United States
(12) Patent Application Publication
(10) Pub. No.: US 2016/0048535 A1
(43) Pub. Date: Feb. 18, 2016

(54) INFORMATION SEARCHING METHOD

(71) Applicant: Chong Yea Shaw, Fremont, CA (US)

(72) Inventor: Chong Yea Shaw, Fremont, CA (US)

(21) Appl. No.: 14/460,341

(22) Filed: Aug. 14, 2014

(51) Int. Cl. G06F 17/30

(52) U.S. Cl. CPC G06F 17/30241; G06F 17/3087

(57) ABSTRACT

An information searching method for a group of websites comprises routing a first user to a first website in the group of websites according to a location of the first user, receiving a search request from the first user, deriving a location of the search request according to the location of the first user or location information inputted by the first user, deriving a plurality of searched targets according to the search request and information stored in a shared storage system of the group of websites, generating rankings of the plurality of searched targets according to distances between the location of the search request and a location of each of the plurality of the searched targets, and displaying the plurality of searched targets according to the rankings of the plurality of searched targets.

### BACKGROUND OF THE INVENTION

1. Field of the Invention

The invention relates to an information searching method, and more particularly, an information searching method considering a location of a user.

2. Description of the Prior Art

As the usages of personal electronic device and the Internet become more and more common, it has become people's daily life to get on the Internet for searching or sharing all kinds of information. Therefore, the information on the Internet is explosively increasing, which makes it harder to search the wanted information instantly and accurately. A common searching method is using keywords matching, which shows the searching results according to the relevance between the keywords entered by the user and the text content of the information. Therefore, irrelevant searching result might be shown as well. For some specific requests, such as for an online auction or for job hunting, there may be some specially designed websites so people can find the relevant information more accurately.

However, in some cases, locations can be one of the main concerns when people search information online. For example, when people are searching job opportunities online, they may be focusing on the job opportunities that are near to their residential areas. Although some of the websites have classified the job opportunities into different categories according to the locations of the job opportunities, it may still not be intuitive enough since people are mostly concerned by the commuting distances, instead of the cities where they work. Furthermore, when people search information within one city, they may miss some good opportunities available in different cities but still near to their residential areas. Therefore, how to help people to search information more efficiently by considering the commuting distances becomes an issue to be solved.

### SUMMARY OF THE INVENTION

One embodiment of the present invention discloses an information searching method for a group of websites. The method comprises routing a first user to a first website in the group of websites according to a location of the first user, receiving a search request from the first user, deriving a location of the search request according to the location of the first user or location information inputted by the first user, deriving a plurality of searched targets according to the search request and information stored in a shared storage system of the group of websites, generating rankings of the plurality of searched targets according to distances between the location of the search request and a location of each of the plurality of the searched targets, and displaying the plurality of searched targets according to the rankings of the plurality of searched targets.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows data flow between user and the group of websites according to one embodiment of the present invention.

FIG. 2 shows data flow between user and the group of websites according to another embodiment of the present invention.

FIG. 3 shows an information searching method for a group of websites according to one embodiment of the present invention.

### DETAILED DESCRIPTION

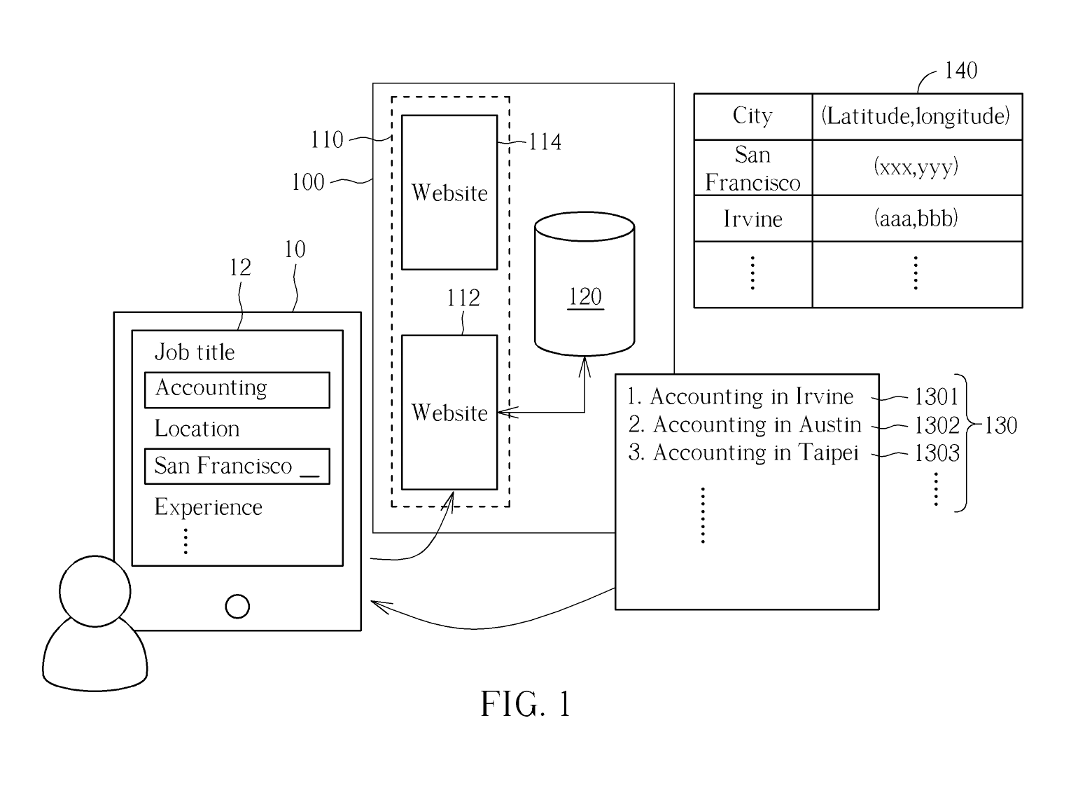

FIG. 1 shows data flow between the first user 10 and the group of websites 100 according to one embodiment of the present invention. The first user 10 can be a laptop, a smart phone, a tablet or any other electronic devices that can browse the Internet. The group of websites 100 comprises a plurality of websites 110 and a shared storage system 120. The plurality of websites 110 can host pages in different languages so it is easier for the users to read the information in their preferred language. In addition, the plurality of websites 110 can also share the information stored in the shared storage system 120.

When the first user 10 connects to the group of websites 100, the first user 10 is firstly routed to a first website 112 according to a location of the first user 10. The first website 112 can show a preferred language of the first user 10 according to the location of the first user 10. For example, if the first user 10 connects to the group of websites 100 from the U.S., the first user 10 may be routed to the first website 112, which shows a first page in English. However, English may not always be the preferred language for some users from the U.S. so language switch links can be provided on the first page for the first user 10 to switch the preferred language.

In one embodiment of the present invention, the location of the first user 10 may be derived by the location information provided by the Internet connection between the first user 10 and the first website 112. The location information of an Internet connection is usually embedded in the package of the Internet connection and can be easily derived by software. In another embodiment of the present invention, the location of the first user can be derived by global positioning system (GPS) coordinates. The GPS coordinates are usually available if the first user is a smart phone or a tablet.

After the first user 10 is routed to the first website 112, the first user 10 can invoke a search request 12. When the first website 112 receives the search request 12, the first website 112 can derive the location of the search request 12 according to the location of the first user 10 or location information inputted by the first user 10. In addition, after the first websites 112 receives the search request 12, the first websites 112 can derive a plurality of searched targets 130 according to the search request 12 and information stored in the shared storage system 120. In one embodiment of the present invention, the plurality of searched targets 130 are derived by matching keywords of the search request 12 with the information stored in the shared storage system 120 and the matched information can be marked as the search targets 130. For example, if the group of websites 100 is to provide a job hunting service, the information stored in the shared storage system 120 may include many job opportunities. Therefore, when the group of websites 100 receives the search request 12, which in this example is looking for jobs related to accounting, the group of websites 100 will check if any of the job opportunities stored in the shared storage system 120 are relevant to the keyword “accounting” of the search request 12, and mark all the relevant information as the plurality of search targets 130. In one embodiment of the present invention, the group of websites 100 can check the job opportunities stored in the shared storage system 120 by software.

The group of websites 100 further generates rankings of each of the searched targets 130 according to distances between the location of the search request and a location of each of the plurality of the searched targets. For example, if the location of the search request is in San Francisco, then a search target 1301 with location in Irvine, Calif., will have a higher ranking than a ranking of a search target 1302 with location in Austin, Tex., since the distance between San Francisco and Irvine is smaller than the distance between San Francisco and Austin. Furthermore, the ranking of the search targets 1302 is higher than the ranking of a search target 1303 with location in Taipei, Taiwan, since the distance between San Francisco and Taipei is larger than the distance between San Francisco and Austin. Finally, the searched targets 130 are displayed according to the rankings of the plurality of searched targets 130, namely, the search target 1301 will be on the first search targets to be shown among the three search targets 1301 to 1303.

In one embodiment of the present invention, the distances between the location of the search request 12 and the location of each of the plurality of the searched targets 130 can be derived by a lookup table 140, which stores latitude and longitude information related to the locations of the search request 12 and location of the searched targets 130. For example, the lookup table 140 may store the latitude and longitude information of San Francisco and Irvine as shown in FIG. 1. The distance between the location of the search request, San Francisco, and the location of the searched target 1301, Irvine, can thus be calculated by comparing the latitude and longitude of San Francisco and the latitude and longitude of Irvine. In one embodiment of the present invention, the lookup table 14 may store the latitude and longitude information with the ZIP codes of different cities. Also, in another embodiment of the present invention, the distances between the location of the search request 12 and the location of each of the plurality of the searched targets 130 can be also derived by the aids of global positioning system (GPS).

In one embodiment of the present invention, the information stored in the shared storage system 120 can be inputted by a system maintainer in advance. However, the information stored in the shared storage system 120 can also be posted by users.

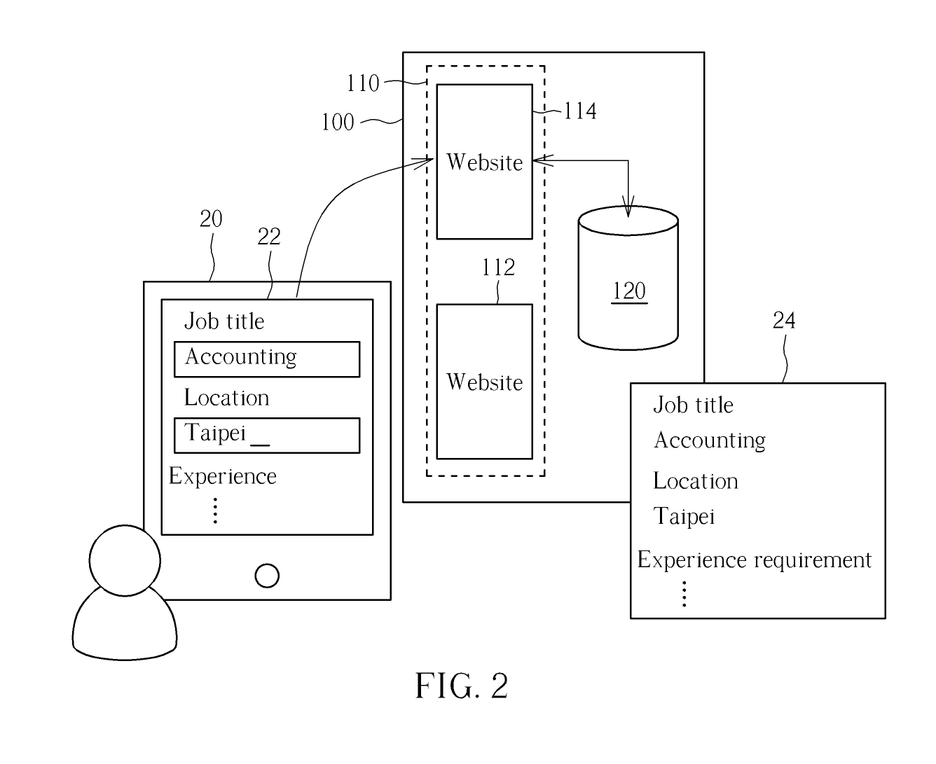

FIG. 2 shows data flow between the second user 20 and the group of websites 100 according to one embodiment of the present invention. The second user 20 is firstly routed to a second website 114 in the group of websites 100 according to a location of the second user 20. That is, if the second user 20 is in Taipei, the second user 20 may be routed to the second website 114, which shows a page in traditional Chinese. The second user 20 can enter posting information 22 through the page. After the posting information 22 is received, the posting information 22 and a location of the posting information are thus stored in the shared storage system 120 as posted information 24. The location of the posting information can be derived by the location of the second user 20 or location information inputted by the second user 20. Consequently, when the first user 10 invokes the search request 12, the searched targets 130 may include the posted information 24 when the posted information 24 matches with the search request. Also, since the posted information 24 is stored in the shared storage system 120, the searched targets 130 may still include the posted information 24 even if the location of the search request 12 is different from the location of the posting information 22. Similarly, even if the second website 114 is different from the first website 112, the search targets 130 corresponding to the search request 12 received by the first website 112 may still include the posted information 24 stored by the second website 114. This can be useful for people who are looking for information that is not only regional information but international information while the factor of distance is still considered.

Consequently, the information searching method according the embodiments of the present invention can help users to search information efficiently by considering the distances between the search request and the search targets.

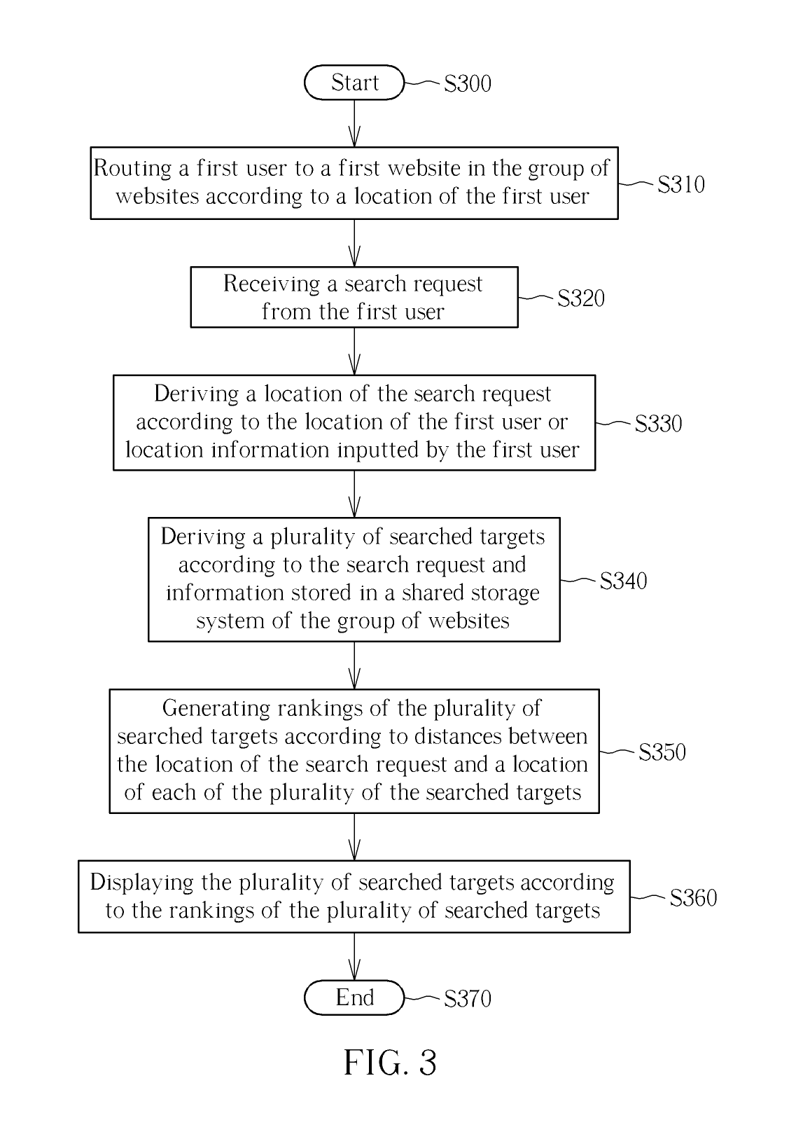

FIG. 3 shows an information searching method for a group of websites according to one embodiment of the present invention. The information searching method in FIG. 3 includes the steps S300 to S370 as shown below.

S300: start;

S310: routing a first user to a first website in the group of websites according to a location of the first user;

S320: receiving a search request from the first user;

S330: deriving a location of the search request according to the location of the first user or location information inputted by the first user;

S340: deriving a plurality of searched targets according to the search request and information stored in a shared storage system of the group of websites;

S350: generating rankings of the plurality of searched targets according to distances between the location of the search request and a location of each of the plurality of the searched targets;

S360: displaying the plurality of searched targets according to the rankings of the plurality of searched targets;

S370: end.

In summary, by using the information searching method according the embodiments of the present invention, a user can look up for information which locates in different regions but still with the consideration of commuting distances.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information searching method for a group of websites, the method comprising:
routing a first user to a first website in the group of websites according to a location of the first user;
receiving a search request from the first user;
deriving a location of the search request according to the location of the first user or location information inputted by the first user;
deriving a plurality of searched targets according to the search request and information stored in a shared storage system of the group of websites;
generating rankings of the plurality of searched targets according to distances between the location of the search request and a location of each of the plurality of the searched targets; and
displaying the plurality of searched targets according to the rankings of the plurality of searched targets.

2. The method of claim 1, further comprises:
showing a first page hosted by the first website in the group of websites with a preferred language of the first user according to the location of the first user.

3. The method of claim 2, further comprises:
providing language switch links on the first page for the first user to switch the preferred language of the first user.

4. The method of claim 1, further comprises:
routing a second user to a second website in the group of websites according to a location of the second user;
receiving a posting information from the second user; and
storing the posting information and a location of the posting information as a posted information in the shared storage system of the group of websites.

5. The method of claim 4, wherein the plurality of searched targets includes the posted information when the posted information matches with the search request.

6. The method of claim 5, wherein the location of the search request is different from the location of the posting information.

7. The method of claim 4, wherein the second website in the group of websites is different from the first website in the group of websites.

8. The method of claim 1, wherein when a distance between the location of the search request and a location of a first searched target is smaller than a distance between the location of the search request and a location of a second searched target, then a ranking of the first searched target is higher than a ranking of the second searched target.

9. The method of claim 1, further comprising:
deriving the distances between the location of the search request and the location of each of the plurality of the searched targets by a lookup table storing latitude and longitude information related to the locations of the search request and location of the searched targets.

10. The method of claim 1, further comprising:
deriving the location of the first user by a location information provided by an Internet connection between the first user and the website.

11. The method of claim 1, further comprising:
deriving the location of the first user by global positioning system (GPS) coordinates.
